(19) United States
(12) Patent Application Publication
(10) Pub. No.: US 2021/0061964 A1
(43) Pub. Date: Mar. 4, 2021

(54) STEREOLITHOGRAPHY ELASTIC FILM WITH ADJUSTABLE PEELING FORCE

(71) Applicants: XYZPRINTING, INC., New Taipei City (TW); KINPO ELECTRONICS, INC., New Taipei City (TW)

(72) Inventors: Yu-Chen CHANG, NEW TAIPEI CITY (TW); Tsung-Hua KUO, NEW TAIPEI CITY (TW)

(21) Appl. No.: 16/667,890

(22) Filed: Oct. 29, 2019

(30) Foreign Application Priority Data
Sep. 2, 2019 (CN) 201910822751.4

(51) Int. Cl. C08J 5/18; B33Y 40/00; B29C 64/379

(52) U.S. Cl. CPC C08J 5/18; B33Y 40/00; C08J 2405/00; C08J 2305/12; C08J 2305/00; B29C 64/379

(57) ABSTRACT

A stereolithography elastic film with adjustable peeling force applied to a stereolithography 3D printing apparatus, and the stereolithography elastic film includes at least one of a first colloid and a second colloid. The first colloid includes a non-polyelectrolyte and water, the water occupies the largest percentage in the first colloid. The second colloid includes a polyelectrolyte, a coagulant and water, the water occupies the largest percentage in the second colloid. The peeling force of the stereolithography elastic film may be adjusted by adjusting the percentage of at least one of the non-polyelectrolyte, the polyelectrolyte, the coagulant, and the water.

### BACKGROUND OF THE INVENTION

### Technical Field

The present disclosure relates to a stereolithography elastic film, and more particularly to a peeling force of a stereolithography elastic film with may be adjusted by adjusting a percentage of various material components.

### Description of Related Art

In general, a stereolithography 3D printing apparatus constructs a 3D printed article using an additive manufacturing technology such as a layer-by-layer construction model. The main purpose is to convert the design data of the 3D printed object constructed by software such as computer aided design (CAD) into a plurality of thin cross-section layers which are continuously stacked, and then the stereolithography 3D printing apparatus moves along an XY plane on a base according to design data constructed by an XYZ space. Thereby, making construction material forms a correct cross-sectional layer shape. Thereafter, by moving the stereolithography 3D printing apparatus along a Z-axis for layer by layer, a plurality of cross-sectional layers can be gradually stacked along the Z-axis, thereby forming the 3D printed article in a layer-by-layer solidified state.

In a process of actually operating the stereolithography 3D printing apparatus, a peel able elastic film is applied, and a general elastic film generates a peeling force during the peeling process. The peeling force begins to increase as the elastic film begins to peel off from the 3D printed article until the peeling force reaches a maximum at an instant when the elastic film is completely separated from the 3D printed article. Further, the peeling force affects processing time and quality of the 3D printed object. For example, if the peeling force is too large, the process time is difficult to be reduced, and the structure at mechanically weak portion of the 3D printed object may be caused. Sexual damage, which in turn affects the quality of the final output of a 3D printed object. However, the generally stereolithography elastic film cannot be adjusted for the peeling force because the material itself is fixed.

Therefore, how to design a stereolithography elastic film with adjustable peeling force to solve the technical problems above is an important subject studied by the inventors and proposed in the present disclosure.

### SUMMARY OF THE INVENTION

One of purpose of the present disclosure is to provide a stereolithography elastic film with adjustable peeling force, which can adjust a percentage of various material components to adjust the peeling force, thereby it can reduce process time, improve process efficiency, and maintain quality for final 3D object.

In order to achieve the objective, the stereolithography elastic film with adjustable peeling force, which is applied to a stereolithography 3D printing apparatus, and the stereolithography elastic film includes a first colloid, the first colloid includes a non-polyelectrolyte and water, the water occupies a largest percentage in the first colloid, a peeling force of the stereolithography elastic film is adjusted by adjusting a percentage of at least one of the non-polyelectrolyte and the water.

Further, the non-polyelectrolyte includes an agar.

Further, a percentage of the agar is between 0.3% and 7%, and a percentage of the water is between 93% and 99.7%.

Further, the stereolithography elastic film with adjustable peeling force further includes a third colloid, the third colloid includes one of locust bean gum (LBG), guar gum and konnyaku.

Further, when the stereolithography elastic film includes the first colloid and the third colloid, the non-polyelectrolyte includes an agar, and the agar forms a synergistic effect with the third colloid.

Further, the percentage of the agar is between 0.3% and 7%, a percentage of the third colloid is between 0.03% and 1.4%, and the percentage of the water is between 91.6% and 99.67%.

Further, the percentage of the agar is between 0.5% and 5%, the percentage of the third colloid is between 0.06% and 1%, and the percentage of the water is between 94% and 99.44%.

Further, the stereolithography elastic film with adjustable peeling force further includes a sweetener, the sweetener includes at least one of a sugar and a sugar alcohol.

In order to achieve the objective, the stereolithography elastic film with adjustable peeling force, which is applied to a stereolithography 3D printing apparatus, and the stereolithography elastic film includes a second colloid includes a polyelectrolyte, a coagulant and water, the water occupies a largest percentage in the second colloid, a peeling force of the stereolithography elastic film may be adjusted by adjusting a percentage of at least one of the polyelectrolyte, the coagulant, and the water.

Further, the polyelectrolyte is a carrageenan.

Further, the carrageenan includes at least one of a Kappa-carrageenan or an Iota-carrageenan.

Further, when the stereolithography elastic film includes the second colloid, and the polyelectrolyte includes the Kappa-carrageenan, the coagulant includes a potash salt.

Further, a percentage of the Kappa-carrageenan is between 0.5% and 10%, a percentage of the potash salt is between 0.2% and 5%, and a percentage of the water is between 85% and 99.3%.

Further, when the stereolithography elastic film includes the second colloid, and the polyelectrolyte includes the Iota-carrageenan, the coagulant includes a calcium salt.

Further, a percentage of the Iota-carrageenan is between 2% and 10%, a percentage of the calcium salt is between 0.2% and 2%, and a percentage of the water is between 88% and 97.8%.

Further, the percentage of the Iota-carrageenan is between 3% and 7%, the percentage of the calcium salt is between 0.3% and 1.5%, and the percentage of the water is between 91.5% and 96.7%.

Further, the stereolithography elastic film with adjustable peeling force further includes a third colloid, the third colloid includes one of locust bean gum (LBG), guar gum and konnyaku.

Further, the polyelectrolyte includes at least one of a Kappa-carrageenan or an Iota-carrageenan, and the Kappa-carrageenan forms a synergistic effect with the third colloid.

Further, the coagulant includes a potash salt, a percentage of the Kappa-carrageenan is between 0.5% and 10%, a percentage of the third colloid is between 0.03% and 1.4%, a percentage of the potash salt is between 0.2% and 5%, and a percentage of the water is between 83.6% and 99.27%.

Further, the percentage of the Kappa-carrageenan is between 0.7% and 7%, the percentage of the third colloid is between 0.06% and 1%, the percentage of the potash salt is between 0.5% and 3.5%, and the percentage of the water is between 88.5% and 98.74%.

Further, when the stereolithography elastic film includes the Kappa-carrageenan, the Iota-carrageenan and the third colloid, the coagulant includes the potash salt and a calcium salt, a percentage of the Kappa-carrageenan is between 0.03% and 2%, a percentage of the Iota-carrageenan is between 2% and 10%, a percentage of the potash salt is between 0% and 5%, a percentage of the calcium salt is between 0.2% and 2%, a percentage of the third colloid is between 0.03% and 1.4%, and a percentage of the water is between 79.6% and 97.74%.

Further, the percentage of the Kappa-carrageenan is between 0.06% and 1.2%, the percentage of the Iota-carrageenan is between 3% and 7%, the percentage of the potash salt is between 0% and 3.5%, a percentage of the calcium salt is between 0.3% and 1.5%, the percentage of the third colloid is between 0.06% and 1%, and the percentage of the water is between 85.8% and 96.58%.

Further, the stereolithography elastic film with adjustable peeling force further includes a sweetener, the sweetener includes at least one of a sugar and a sugar alcohol.

Another one of purpose of the present disclosure is to provide a stereolithography elastic film with adjustable peeling force, which can adjust a percentage of various material components to adjust the peeling force, thereby it can reduce process time, improve process efficiency, and maintain quality for final 3D object.

In order to achieve the another one objective, the stereolithography elastic film with adjustable peeling force, which is applied to a stereolithography 3D printing apparatus, and the stereolithography elastic film includes a first colloid and a sweetener, the first colloid includes a non-polyelectrolyte and water, the sweetener includes at least one of a sugar and a sugar alcohol, a peeling force of the stereolithography elastic film may be adjusted by adjusting a percentage of at least one of the non-polyelectrolyte, the sweetener and the water.

Further, the stereolithography elastic film with adjustable peeling force further includes a third colloid, the third colloid includes one of locust bean gum (LBG), guar gum and konnyaku, and the non-polyelectrolyte includes an agar, a percentage of the agar is between 0.3% and 7%, a percentage of the third colloid is between 0% and 1.4%, a percentage of the sweetener is between 1% and 60%, and a percentage of the water is between 31.6% and 98.7%.

Further, the percentage of the agar is between 0.5% and 5%, the percentage of the third colloid is between 0% and 1%, the percentage of the sweetener is between 5% and 55%, and the percentage of the water is between 39% and 94.5%.

In order to achieve the another one objective, the stereolithography elastic film with adjustable peeling force, which is applied to a stereolithography 3D printing apparatus, and the stereolithography elastic film includes a second colloid and a sweetener, the second colloid includes a polyelectrolyte, a coagulant and water, the sweetener includes at least one of a sugar and a sugar alcohol, a peeling force of the stereolithography elastic film may be adjusted by adjusting a percentage of at least one of the polyelectrolyte, the coagulant, the sweetener and the water.

Further, the stereolithography elastic film with adjustable peeling force further includes a third colloid, the third colloid includes one of locust bean gum (LBG), guar gum and konnyaku, the polyelectrolyte includes a Kappa-carrageenan, and the coagulant includes a potash salt, a percentage of the Kappa-carrageenan is between 0.5% and 10%, a percentage of the third colloid is between 0% and 1.4%, a percentage of the potash salt is between 0% and 5%, a percentage of the sweetener is between 1% and 55%, and a percentage of the water is between 28.6% and 98.5%.

Further, the percentage of the Kappa-carrageenan is between 0.7% and 7%, the percentage of the third colloid is between 0% and 1%, the percentage of the potash salt is between 0.1% and 3.5%, the percentage of the sweetener is between 5% and 50%, and the percentage of the water is between 38.5% and 94.2%.

Further, the stereolithography elastic film with adjustable peeling force further includes an Iota-carrageenan, and the coagulant includes a calcium salt, a percentage of the Iota-carrageenan is between 2% and 10%, the percentage of the Kappa-carrageenan is between 0.03% and 2%, the percentage of the third colloid is between 0% and 1.4%, a percentage of the calcium salt is between 0% and 2%, the percentage of the potash salt is between 0% and 5%, the percentage of the sweetener is between 1% and 40%, and the percentage of the water is between 39.6% and 96.97%.

Further, the percentage of the Iota-carrageenan is between 3% and 7%, the percentage of the Kappa-carrageenan is between 0.06% and 1.2%, the percentage of the third colloid is between 0% and 1%, the percentage of the calcium salt is between 0.1% and 1.5%, the percentage of the potash salt is between 0% and 3.5%, the percentage of the sweetener is between 5% and 30%, and the percentage of the water is between 55.8% and 91.84%.

When the stereolithography elastic film with adjustable peeling force of the present disclosure is used, the peeling force of the stereolithography elastic film can be adjusted by adjusting the percentage of at least one of the non-polyelectrolyte, the polyelectrolyte, the coagulant, and water. Further, the non-polyelectrolyte or the polyelectrolyte may from a synergistic effect with the third colloid (for example, locust bean gum (LBG), guar gum or konnyaku) to change physical properties of mixture, so that a peeling force of the mixture can be adjusted precisely at different precision. Still further, the non-polyelectrolyte or polyelectrolyte may be combined with the third colloid and the sweetener (for example, a sugar or a sugar alcohol), or only combined with the sweetener to change physical properties of mixture, so that a peeling force of the mixture can be adjusted precisely at different precision. Therefore, the stereolithography elastic film with adjustable peeling force of the present disclosure can be adjusted precisely at different precision by various different methods above mentioned to reduce process time, improve process efficiency, and maintain quality for final 3D object.

In order to further understand the techniques, means, and effects of the present disclosure for achieving the intended purpose. Please refer to the following detailed description and drawings of the present disclosure. The drawings are provided for reference and description only, and are not intended to limit the present disclosure.

### BRIEF DESCRIPTION OF DRAWINGS

FIG. 1 and FIG. 2 are schematic views showing an operation of the stereolithography elastic film of the present disclosure applied to a stereolithography 3D printing apparatus.

FIG. 3 is a composition view showing a first embodiment of a stereolithography elastic film of the present disclosure.

FIG. 4 is a composition view showing a second embodiment of a stereolithography elastic film of the present disclosure.

FIG. 5 is a composition view showing a third embodiment of a stereolithography elastic film of the present disclosure.

FIG. 6 is a composition view showing a fourth embodiment of a stereolithography elastic film of the present disclosure.

FIG. 7 is a composition view showing a fifth embodiment of a stereolithography elastic film of the present disclosure.

FIG. 8 is a composition view showing a sixth embodiment of a stereolithography elastic film of the present disclosure.

FIG. 9 is a composition view showing a seventh embodiment of a stereolithography elastic film of the present disclosure.

FIG. 10 is a composition view showing an eighth embodiment of a stereolithography elastic film of the present disclosure.

### DETAILED DESCRIPTION OF THE INVENTION

The embodiments of the present disclosure are described by way of specific examples, and those skilled in the art can readily appreciate the other advantages and functions of the present disclosure. The present disclosure may be embodied or applied in various other specific embodiments, and various modifications and changes can be made without departing from the spirit and scope of the present disclosure.

It should be understood that the structures, the proportions, the sizes, the number of components, and the like in the drawings are only used to cope with the contents disclosed in the specification for understanding and reading by those skilled in the art, and it is not intended to limit the conditions that can be implemented in the present disclosure, and thus is not technically significant. Any modification of the structure, the change of the proportional relationship, or the adjustment of the size, should be within the scope of the technical contents disclosed by the present disclosure without affecting the effects and the achievable effects of the present disclosure.

The technical content and detailed description of the present disclosure will be described below in conjunction with the drawings.

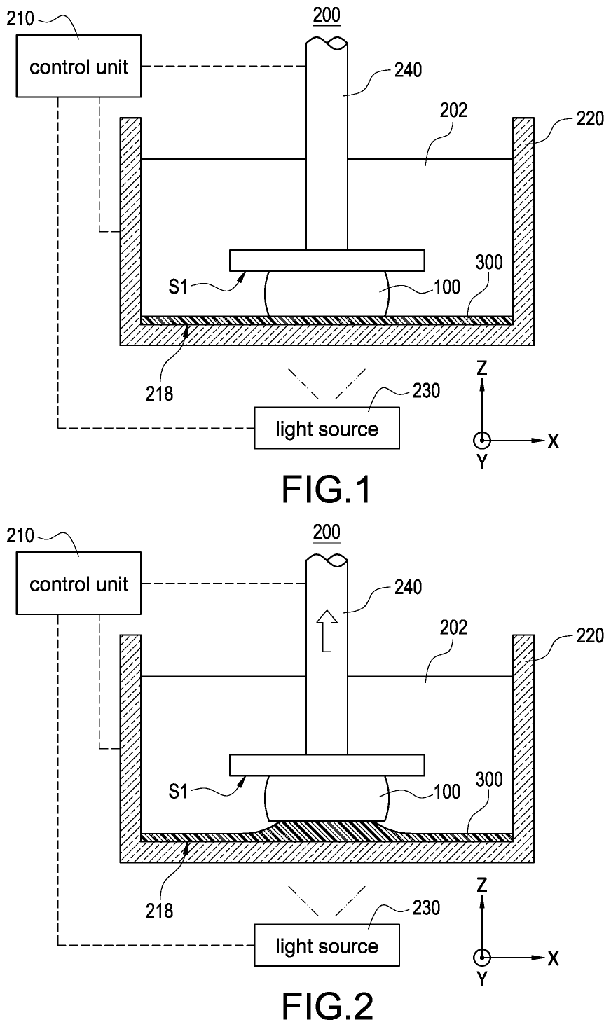

Please refer to FIG. 1 and FIG. 2 are schematic views showing an operation of the stereolithography elastic film of the present disclosure applied to a stereolithography 3D printing apparatus. In the present embodiment, the stereolithography 3D printing apparatus 200 may include a control unit 210, a tank 220, a light source 230, and a moving platform 240, which provide a rectangular coordinate system to facilitate describing the related components and their motion states. The tank 220 is used to hold the liquid molding material 202, and the moving platform 240 is controlled by the control unit 210 to be movably disposed on the tank 220 along Z axis. Thereby, the moving platform 240 can be removed from the tank 220 or moved into the tank 220 and immersed in the liquid molding material 202.

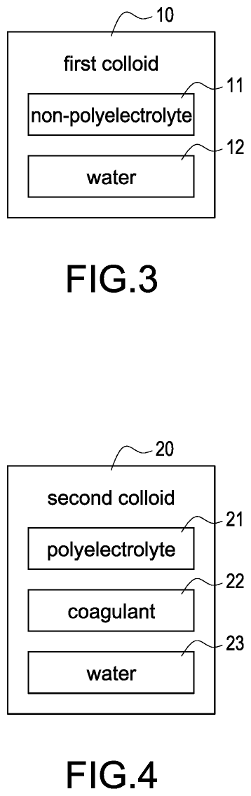

Please refer to FIG. 3 and FIG. 4. FIG. 3 is a composition view showing a first embodiment of a stereolithography elastic film of the present disclosure. FIG. 4 is a composition view showing a second embodiment of a stereolithography elastic film of the present disclosure.

The stereolithography elastic film with adjustable peeling force of a first embodiment of the present disclosure is applied to a stereolithography 3D printing apparatus, and the stereolithography elastic film includes a first colloid 10 or a second colloid 20. FIG. 1 and FIG. 2 are views for adjusting the peeling force by merely adjusting the hydrocolloids concentration (water content ratio). The hydrocolloids may be the first colloid 10 or the second colloid 20 constituting the stereolithography elastic film.

As shown in FIG. 3, in the first embodiment of the present disclosure, when the stereolithography elastic film includes at least the first colloid 10, the first colloid 10 includes a non-polyelectrolyte 11 and water 12, and the water 12 occupies a largest percentage in the first colloid 10. A peeling force of the stereolithography elastic film can be adjusted by adjusting a percentage of at least one of the non-polyelectrolyte 11 and the water 12. In the first embodiment of the present disclosure, the non-polyelectrolyte 11 may be agar. Further, when the stereolithography elastic film includes only the first colloid 10, a percentage of the agar is between 0.3% and 7%, and a percentage of the water is between 93% and 99.7%. In another aspect of the first embodiment of the present disclosure, the percentage of the agar is between 0.5% and 5%, and the percentage of the water 12 is between 95% and 99.5%. The stereolithography elastic film of the disclosure can firstly determine the percentage of the material which occupies less percentage of total, and finally add water to 100% of the total amount required. Of course, it can also determine amount of water added, and then determine the percentage of the material which occupies less percentage of total, as long as the total amount is 100%. In the first embodiment, when the percentage of the agar is 7% (the upper limit of the agar), the percentage of the water to be added is 93% (the lower limit of the water). On the other hand, when the percentage of the agar is 0.3% (the lower limit of the agar), the percentage of the water to be added is 99.7% (the upper limit of the water). However, the scope of protection of the present disclosure is not limited thereto.

As shown in FIG. 4, in second embodiment of the present disclosure, when the stereolithography elastic film includes at least the second colloid 20, the second colloid 20 includes a polyelectrolyte 21, a coagulant 22, and water 23, and the water 23 occupies a largest percentage in the second colloid 20. A peeling force of the stereolithography elastic film may be adjusted by adjusting a percentage of at least one of the polyelectrolyte 21, the coagulant 22, and the water 23. The polyelectrolyte 21 is a long-chain polymer having an ionizable group, and ionizes in a polar solvent to charge a polymer chain. Further, the polyelectrolyte 21 may be carrageenan, and the carrageenan includes at least one of a Kappa-carrageenan or an Iota-carrageenan. When the stereolithography elastic film includes the second colloid 20, and the polyelectrolyte 21 includes the Kappa-carrageenan, the coagulant 22 includes a potash salt. When the stereolithography elastic film includes the second colloid 20, and the polyelectrolyte 21 includes the Iota-carrageenan, the coagulant 22 includes a calcium salt.

In a second embodiment of the present disclosure, when the stereolithography elastic film includes only the second colloid 20 and the polyelectrolyte 21 includes only Kappa-carrageenan, a percentage of the Kappa-carrageenan is between 0.5% and 10%, a percentage of the potash salt is between 0.2% and 5%, and a percentage of the water is between 85% and 99.3%. In another aspect of the second embodiment of the present disclosure, the percentage of the Kappa-carrageenan is between 0.7% and 7%, the percentage of the potash salt is between 0.5% and 3.5%, and the percentage of the water 23 is between 89.5% and 98.8%. In the second embodiment, when the stereolithography elastic film includes only the second colloid 20 and the polyelectrolyte 21 includes only Kappa-carrageenan, the ratio of other less materials is the upper limit (the percentage of Kappa-carrageenan is 10%, the percentage of potash salt is 5%), and the percentage of water 23 must be 85% of the lower limit. On the other hand, when the percentage of water 23 is 99.3% (the upper limit), the other must be the lower limit (the percentage of Kappa-carrageenan is 0.5%, the percentage of potash salt is 0.2%). However, the scope of protection of the present disclosure is not limited thereto.

In the second embodiment of the present disclosure, when the stereolithography elastic film includes only the second colloid 20 and the polyelectrolyte 21 includes only Iota-carrageenan, the percentage of the Iota-carrageenan is between 2% and 10%, and the percentage of the calcium salt is between 0.2% and 2%, and the percentage of water 23 is between 88% and 97.8%. In another aspect of the first embodiment of the present disclosure, the percentage of the Iota-carrageenan is between 3% and 7%, the percentage of the calcium salt is between 0.3% and 1.5%, and the percentage of the water 23 is between 91.5% and 96.7%. In the second embodiment, when the stereolithography elastic film includes only the second colloid 20 and the polyelectrolyte 21 includes only Iota-carrageenan, the percentage of water 23 is 88% (the lower limit), the other materials must be the upper limit (the percentage of the Iota-carrageenan is 10%, the percentage of the calcium salt is 2%). On the other hand, when the percentage of water 23 is 97.8% (the upper limit), the other materials must be the lower limit (the percentage of Iota-carrageenan is 2%, and the percentage of calcium salt is 0.2%). However, the scope of protection of the present disclosure is not limited thereto.

In general, if the hydrocolloid has lower concentration, the peel force of the hydrocolloid is smaller. However, if the concentration of the hydrocolloid is too low, it will affect the overall mechanical strength of the hydrocolloid, and even cause the hydrocolloid to fail to form. Therefore, it is necessary to consider the combination of the third colloid 30 or the sweetener 40 for a more precise adjustment.

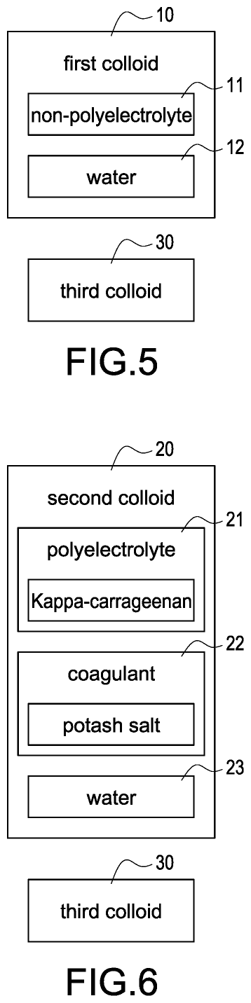

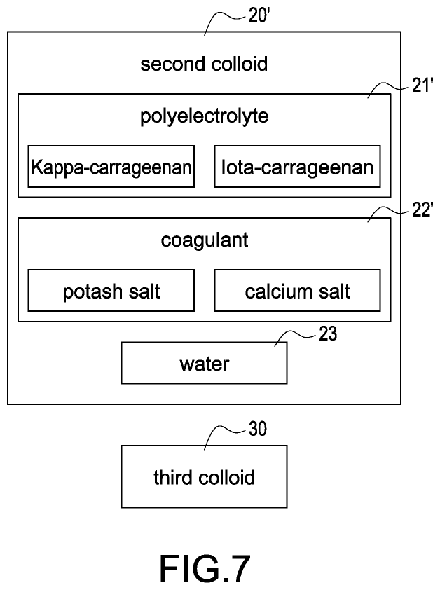

Please refer to FIG. 5 to FIG. 7. FIG. 5 is a composition view showing a third embodiment of a stereolithography elastic film of the present disclosure. FIG. 6 is a composition view showing a fourth embodiment of a stereolithography elastic film of the present disclosure. FIG. 7 is a composition view showing a fifth embodiment of a stereolithography elastic film of the present disclosure. When agar or Kappa-carrageenan is mixed with a certain type of hydrocolloid (for example, the third colloid 30), a synergistic effect is generated, which can greatly change the physical properties and texture of the original colloids, and may increase the gel strength. The texture can be changed from hard and brittle to elastic and can be used to adjust for peel force. Or it can be mixed with Iota-carrageenan which has been very low in peeling force to enhance mechanical strength.

As shown in FIG. 5, the third embodiment of the present disclosure is substantially the same as the first embodiment, but further includes a third colloid 30, and the third colloid 30 includes one of locust bean gum (LBG), guar gum and konnyaku. When the stereolithography elastic film includes the first colloid 10 and the third colloid 30, the non-polyelectrolyte 11 includes agar, and the agar forms a synergistic effect with the third colloid 30. In the third embodiment of the stereolithography elastic film of the present disclosure, the percentage of the agar is between 0.3% and 7%, a percentage of the third colloid 30 is between 0.03% and 1.4%, and the percentage of the water 12 is between 91.6% and 99.67%. In another aspect of the third embodiment of the present disclosure, the percentage of the agar is between 0.5% and 5%, the percentage of the third colloid 30 is between 0.06% and 1%, and the percentage of the water 12 is between 94.0% and 99.44%. In the third embodiment, when the percentage of water is 91.6% (the lower limit), the other materials must be the upper limit (the percentage of the agar is 7%, and the percentage of the third colloid 30 is 1.4%). On the other hand, when the percentage of water is 99.67% (the upper limit), the other materials must be the lower limit (the percentage of the agar is 0.3%, and the percentage of the third colloid 30 is 0.03%). However, the scope of protection of the present disclosure is not limited thereto.

As shown in FIG. 6, in the fourth embodiment of the present disclosure, when the stereolithography elastic film includes the second colloid 20 and the third colloid 30, and the polyelectrolyte 21 includes only Kappa-carrageenan, the Kappa-carrageenan forms a synergistic effect with the third colloid 30. A percentage of the Kappa-carrageenan is between 0.5% and 10%, a percentage of the third colloid 30 is between 0.03% and 1.4%, a percentage of the potash salt is between 0.2% and 5%, and a percentage of the water 23 is between 83.6% and 99.27%. In another aspect of the third embodiment of the present disclosure, the percentage of the Kappa-carrageenan is between 0.7% and 7%, the percentage of the third colloid 30 is between 0.06% and 1%, the percentage of the potash salt is between 0.5% and 3.5%, and the percentage of the water 23 is between 88.5% and 98.74%. In the fourth embodiment, when the percentage of water 23 is 83.6% (the lower limit), the other materials must be the upper limit (the percentage of the Kappa-carrageenan is 10%, the percentage of the third colloid 30 is 1.4%, and the percentage of potash salt is 5%). On the other hand, when the percentage of water is 99.27% (the upper limit), the other materials must be the lower limit (the percentage of the Kappa-carrageenan is 0.5%, the percentage of the third colloid 30 is 0.03%, and the percentage of potash salt is 0.2%). However, the scope of protection of the present disclosure is not limited thereto.

As shown in FIG. 7, in the fifth embodiment of the present disclosure, when the stereolithography elastic film includes the second colloid 20′ and the third colloid 30, and the polyelectrolyte 21′ includes the Kappa-carrageenan and Iota-carrageenan, the Kappa-carrageenan forms a synergistic effect with the third colloid 30. The coagulant 22′ includes the potash salt and the calcium salt. A percentage of the Kappa-carrageenan is between 0.03% and 2%, a percentage of the Iota-carrageenan is between 2% and 10%, a percentage of the potash salt is between 0% and 5%, a percentage of the calcium salt is between 0.2% and 2%, a percentage of the third colloid 30 is between 0.03% and 1.4%, and a percentage of the water 23 is between 79.6% and 97.74%. In another aspect of the fifth embodiment of the present disclosure, the percentage of the Kappa-carrageenan is between 0.06% and 1.2%, the percentage of the Iota-carrageenan is between 3% and 7%, the percentage of the potash salt is between 0% and 3.5%, a percentage of the calcium salt is between 0.3% and 1.5%, the percentage of the third colloid 30 is between 0.06% and 1%, and the percentage of the water 23 is between 85.8% and 96.58%. In the fifth embodiment, when the percentage of water is 79.6% (the lower limit), the other materials must be the upper limit (the percentage of the Kappa-carrageenan is 2%, the percentage of the Iota-carrageenan is 10%, the percentage of potash salt is 5%, the percentage of the calcium salt is 2%, and the percentage of the third colloid 30 is 1.4%). On the other hand, when the percentage of water is 97.74% (the upper limit), the other must be the lower limit (the percentage of the Kappa-carrageenan is 0.03%, the percentage of the Iota-carrageenan is 2%, the percentage of potash salt is 0%, the percentage of calcium salt is 0.2%, and the percentage of the third colloid 30 is 0.03%). However, the scope of protection of the present disclosure is not limited thereto.

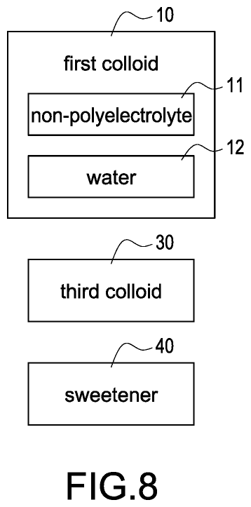

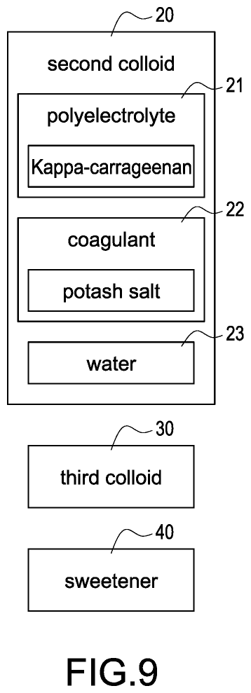

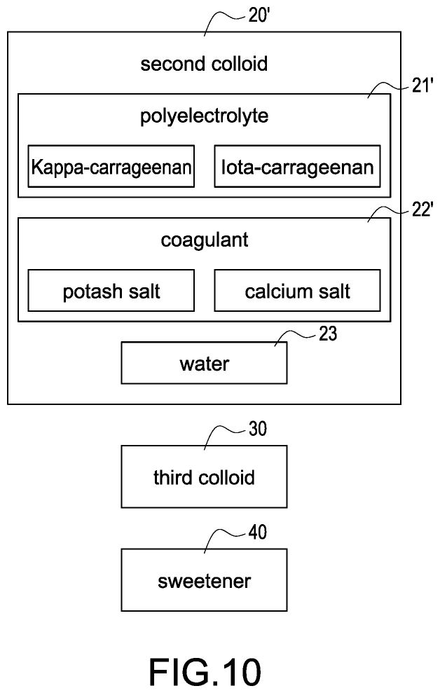

Please refer to FIG. 8 to FIG. 10. FIG. 8 is a composition view showing a sixth embodiment of a stereolithography elastic film of the present disclosure. FIG. 9 is a composition view showing a seventh embodiment of a stereolithography elastic film of the present disclosure. FIG. 10 is a composition view showing an eighth embodiment of a stereolithography elastic film of the present disclosure.

As shown in FIG. 8, the sixth embodiment of the present disclosure is substantially the same as the third embodiment, but further includes a sweetener 40. The sweetener 40 includes at least one of a sugar and a sugar alcohol, primarily a carbohydrate, which can be used to adjust the peel force. The sugar alcohol refers to a polyol formed by reduction of an aldehyde or a ketone carbonyl group of a saccharide to a hydroxyl group, and a formula H(CHOH)ₙ₊₁H. A small amount of sugar alcohol exists in nature, generally colorless crystals, and the solubility is inferior to the corresponding sugar. It has a sweet taste, absorbs heat at the entrance, has a refreshing sensation, is edible, and can absorb and metabolize the body. When the stereolithography elastic film includes the first colloid 10, the third colloid 30, and the sweetener 40, the non-polyelectrolyte 11 includes agar. In the sixth embodiment of the present disclosure, the percentage of the agar is between 0.3% and 7%, the percentage of the third colloid 30 is between 0% and 1.4%, and the percentage of the sweetener 40 is between 1% and 60%. The percentage of water 12 is between 31.6% and 98.7%. In another aspect of the sixth embodiment of the present disclosure, the percentage of the agar is between 0.5% and 5%, the percentage of the third colloid 30 is between 0% and 1%, the percentage of the sweetener 40 is between 5% and 55%, and the percentage of the water 12 is between 39% and 94.5%. In the sixth embodiment, when the percentage of water is 31.6% (the lower limit), the other materials must be the upper limit (the percentage of the agar is 7%, the percentage of the third colloid 30 is 1.4%, and the percentage of the sweetener 40 is 60%). On the other hand, when the percentage of water is 98.7% (the upper limit), the other materials must be the lower limit (the percentage of the agar is 0.3%, the percentage of the third colloid 30 is 0%, and the percentage of the sweetener 40 is 1%). However, the scope of protection of the present disclosure is not limited thereto.

As shown in FIG. 9, the seventh embodiment of the present disclosure is substantially the same as the fourth embodiment, but further includes the sweetener 40. When the stereolithography elastic film includes the second colloid 20, the third colloid 30, and the sweetener 40, the polyelectrolyte 21 includes the Kappa-carrageenan, and the coagulant 22 includes the potash salt. In the seventh embodiment of the present disclosure, a percentage of the Kappa-carrageenan is between 0.5% and 10%, a percentage of the third colloid 30 is between 0% and 1.4%, a percentage of the potash salt is between 0% and 5%, a percentage of the sweetener 40 is between 1% and 55%, and a percentage of the water 23 is between 28.6% and 98.5%. In another aspect of the seventh embodiment of the present disclosure, the percentage of the Kappa-carrageenan is between 0.7% and 7%, the percentage of the third colloid 30 is between 0% and 1%, the percentage of the potash salt is between 0.1% and 3.5%, the percentage of the sweetener 40 is between 5% and 50%, and the percentage of the water 23 is between 38.5% and 94.2%. In the seventh embodiment, when the percentage of water 23 is 28.6% (the lower limit), the other materials must be the upper limit (the percentage of the Kappa-carrageenan is 10%, the percentage of the third colloid 30 is 1.4%, the percentage of potash salt is 5%, and the percentage of sweetener 40 is 55%). On the other hand, when the percentage of water is 98.5% (the upper limit), the other materials must be the lower limit (the percentage of the Kappa-carrageenan 0.5%, third percentage of the colloid 30 is 0%, the percentage of potash is 0%, the percentage of sweetener 40 is 1%). However, the scope of protection of the present disclosure is not limited thereto.

As shown in FIG. 10, the eighth embodiment of the present disclosure is substantially the same as the seventh embodiment, except that the polyelectrolyte 21′ of the second colloid 20′ further includes the Iota-carrageenan, and the coagulant 22′ further includes the calcium salt. A percentage of the Iota-carrageenan is between 2% and 10%, the percentage of the Kappa-carrageenan is between 0.03% and 2%, the percentage of the third colloid 30 is between 0% and 1.4%, a percentage of the calcium salt is between 0% and 2%, the percentage of the potash salt is between 0% and 5%, the percentage of the sweetener 40 is between 1% and 40%, and the percentage of the water 23 is between 39.6% and 96.97%. In another aspect of the eighth embodiment of the present disclosure, the percentage of the Iota-carrageenan is between 3% and 7%, the percentage of the Kappa-carrageenan is between 0.06% and 1.2%, the percentage of the third colloid 30 is between 0% and 1%, the percentage of the calcium salt is between 0.1% and 1.5%, the percentage of the potash salt is between 0% and 3.5%, the percentage of the sweetener 40 is between 5% and 30%, and the percentage of the water 23 is between 55.8% and 91.84%. In the eighth embodiment, when the percentage of water 23 is 39.6% (the lower limit), the other materials must be the upper limit (the percentage of the Iota-carrageenan is 10%, the percentage of the Kappa-carrageenan is 2%, the percentage of the third colloid 30 is 1.4%, the percentage of calcium salt is 2%, the percentage of potash salt is 5%, and the percentage of sweetener 40 is 40%). On the other hand, when the percentage of water is 96.97% (the upper limit), the other materials must be the lower limit (the percentage of the Iota-carrageenan is 2%, the percentage of the Kappa-carrageenan is 0.03%, the percentage of the third colloid 30 is 0%, the percentage of calcium salt is 0%, the percentage of the potash salt is 0%, and the percentage of the sweetener 40 is 1%). However, the scope of protection of the present disclosure is not limited thereto.

Please refer to FIG. 1 and FIG. 2. In detail, the stereolithography elastic film 300 of the present disclosure can be covered on the bottom 218 of the tank 220. The stereolithography 3D printing apparatus 200 irradiates light onto the molding surface Si of the moving platform 240 by the light source 230 to solidify the liquid molding material 202 between the molding surface Si and the stereolithography elastic film 300. And the control unit 210 gradually drives the moving platform 240 away from the bottom 218 of the tank 220 along the Z axis, thereby obtaining a solidified 3D object 100. Moreover, while the moving platform 240 moves along the Z axis, the 3D object 100 pulls with the stereolithography elastic film 300 to generate a peeling force to disengage the 3D object 100 from the stereolithography elastic film 300. If the peeling force is large, in addition to possibly reducing the process speed, the 3D object 100 may be damaged. If the peeling force is small, the process speed can be increased, and the damage to the 3D object 100 can be reduced. At this time, the adjustment of the peeling force between the stereolithography elastic film 300 and the 3D object 100 is the focus of the present disclosure, as will be described in detail below.

When the stereolithography elastic film with adjustable peeling force of the present disclosure is used, the peeling force of the stereolithography elastic film can be adjusted by adjusting the percentage of at least one of the non-polyelectrolyte 11, the polyelectrolyte 21, the coagulant 22, and water 12, 23. Further, the non-polyelectrolyte 11 or the polyelectrolyte 21 may form a synergistic effect with the third colloid 30 (for example, locust bean gum (LBG), guar gum or konnyaku) to change physical properties of mixture, so that a peeling force of the mixture can be adjusted precisely at different precision. Still further, the non-polyelectrolyte 11 or polyelectrolyte 21 may be combined with the third colloid 30 and the sweetener 40 (for example, a sugar or a sugar alcohol), or only combined with the sweetener 40 to change physical properties of mixture, so that a peeling force of the mixture can be adjusted precisely at different precision. Therefore, the stereolithography elastic film with adjustable peeling force of the present disclosure can be adjusted precisely at different precision by various different methods above mentioned to reduce process time, improve process efficiency, and maintain quality for final 3D object 100.

The above is only a detailed description and drawings of the preferred embodiments of the present disclosure, but the features of the present disclosure are not limited thereto, and are not intended to limit the present disclosure. All the scope of the present disclosure shall be subject to the scope of the following claims. The embodiments of the spirit of the present disclosure and its similar variations are intended to be included in the scope of the present disclosure. Any variation or modification that can be easily conceived by those skilled in the art in the field of the present disclosure can be covered by the following claims.

What is claimed is:

1. A stereolithography elastic film with adjustable peeling force applied to a stereolithography 3D printing apparatus, and the stereolithography elastic film comprising:
a first colloid including a non-polyelectrolyte and water, the water occupying a largest percentage in the first colloid,
wherein a peeling force of the stereolithography elastic film is adjusted by adjusting a percentage of at least one of the non-polyelectrolyte and the water.

2. The stereolithography elastic film with adjustable peeling force in claim 1, wherein the non-poly electrolyte includes an agar.

3. The stereolithography elastic film with adjustable peeling force in claim 2, wherein the percentage of the agar is between 0.3% and 7%, and the percentage of the water is between 93% and 99.7%.

4. The stereolithography elastic film with adjustable peeling force in claim 3, wherein the percentage of the agar between is 0.5% and 5%, and the percentage of the water is between 95% and 99.5%.

5. The stereolithography elastic film with adjustable peeling force in claim 1, further comprising a third colloid, the third colloid including one of locust bean gum (LBG), guar gum and konnyaku.

6. The stereolithography elastic film with adjustable peeling force in claim 5, wherein when the stereolithography elastic film includes the first colloid and the third colloid, the non-polyelectrolyte includes an agar, and the agar forms a synergistic effect with the third colloid.

7. The stereolithography elastic film with adjustable peeling force in claim 6, wherein the percentage of the agar is between 0.3% and 7%, the percentage of the third colloid is between 0.03% and 1.4%, and the percentage of the water is between 91.6% and 99.67%.

8. The stereolithography elastic film with adjustable peeling force in claim 7, wherein the percentage of the agar is between 0.5% and 5%, the percentage of the third colloid is between 0.06% and 1%, and the percentage of the water is between 94% and 99.44%.

9. The stereolithography elastic film with adjustable peeling force in claim 1, further comprising a sweetener, the sweetener including at least one of a sugar and a sugar alcohol.

10. A stereolithography elastic film with adjustable peeling force applied to a stereolithography 3D printing apparatus, and the stereolithography elastic film comprising:
a second colloid including a polyelectrolyte, a coagulant and water, the water occupying a largest percentage in the second colloid,
wherein a peeling force of the stereolithography elastic film is adjusted by adjusting a percentage of at least one of the polyelectrolyte, the coagulant, and the water.

11. The stereolithography elastic film with adjustable peeling force in claim 10, wherein the polyelectrolyte is a carrageenan.

12. The stereolithography elastic film with adjustable peeling force in claim 11, wherein the carrageenan includes at least one of a Kappa-carrageenan or an Iota-carrageenan.

13. The stereolithography elastic film with adjustable peeling force in claim 12, wherein when the stereolithography elastic film includes the second colloid, and the polyelectrolyte includes the Kappa-carrageenan, the coagulant includes a potash salt.

14. The stereolithography elastic film with adjustable peeling force in claim 13, wherein a specific gravity of the Kappa-carrageenan is between 0.5% and 10%, the percentage of the potash salt is between 0.2% and 5%, and the percentage of the water is between 85% and 99.3%.

15. The stereolithography elastic film with adjustable peeling force in claim 14, wherein the percentage of the Kappa-carrageenan is between 0.7% and 7%, the percentage of the potash salt is between 0.5% and 3.5%, and the percentage of the water is between 89.5% and 98.8%.

16. The stereolithography elastic film with adjustable peeling force in claim 12, wherein when the stereolithography elastic film includes the second colloid, and the polyelectrolyte includes the Iota-carrageenan, the coagulant includes a calcium salt.

17. The stereolithography elastic film with adjustable peeling force in claim 16, wherein the percentage of the Iota-carrageenan is between 2% and 10%, the percentage of the calcium salt is between 0.2% and 2%, and the percentage of the water is between 88% and 97.8%.

18. The stereolithography elastic film with adjustable peeling force in claim 17, wherein the percentage of the Iota-carrageenan is between 3% and 7%, the percentage of the calcium salt is between 0.3% and 1.5%, and the percentage of the water is between 91.5% and 96.7%.

19. The stereolithography elastic film with adjustable peeling force in claim 10, further comprising a third colloid, the third colloid including one of locust bean gum (LBG), guar gum and konnyaku.

20. The stereolithography elastic film with adjustable peeling force in claim 19, wherein the polyelectrolyte includes at least one of a Kappa-carrageenan or an Iota-carrageenan, and the Kappa-carrageenan forms a synergistic effect with the third colloid.

21. The stereolithography elastic film with adjustable peeling force in claim 20, wherein the coagulant includes a potash salt, the percentage of the Kappa-carrageenan is between 0.5% and 10%, the percentage of the third colloid is between 0.03% and 1.4%, the percentage of the potash salt is between 0.2% and 5%, and the percentage of the water is between 83.6% and 99.27%.

22. The stereolithography elastic film with adjustable peeling force in claim 21, wherein the percentage of the Kappa-carrageenan is between 0.7% and 7%, the percentage of the third colloid is between 0.06% and 1%, the percentage of the potash salt is between 0.5% and 3.5%, and the percentage of the water is between 88.5% and 98.74%.

23. The stereolithography elastic film with adjustable peeling force in claim 20, wherein when the stereolithography elastic film includes the Kappa-carrageenan, the Iota-carrageenan and the third colloid, the coagulant includes the potash salt and a calcium salt, wherein the percentage of the Kappa-carrageenan is between 0.03% and 2%, the percentage of the Iota-carrageenan is between 2% and 10%, the percentage of the potash salt is between 0% and 5%, the percentage of the calcium salt is between 0.2% and 2%, the percentage of the third colloid is between 0.03% and 1.4%, and the percentage of the water is between 79.6% and 97.74%.

24. The stereolithography elastic film with adjustable peeling force in claim 23, wherein the percentage of the Kappa-carrageenan is between 0.06% and 1.2%, the percentage of the Iota-carrageenan is between 3% and 7%, the percentage of the potash salt is between 0% and 3.5%, the percentage of the calcium salt is between 0.3% and 1.5%, the percentage of the third colloid is between 0.06% and 1%, and the percentage of the water is between 85.8% and 96.58%.

25. The stereolithography elastic film with adjustable peeling force in claim 10, further comprising a sweetener, the sweetener including at least one of a sugar and a sugar alcohol.

26. A stereolithography elastic film with adjustable peeling force applied to a stereolithography 3D printing apparatus, and the stereolithography elastic film comprising:
a first colloid including a non-polyelectrolyte and water, and
a sweetener including at least one of a sugar and a sugar alcohol,
wherein a peeling force of the stereolithography elastic film is adjusted by adjusting a percentage of at least one of the non-polyelectrolyte, the sweetener and the water.

27. The stereolithography elastic film with adjustable peeling force in claim 26, further comprising a third colloid, the third colloid including one of locust bean gum (LBG), guar gum and konnyaku, and the non-polyelectrolyte including an agar, wherein the percentage of the agar is between 0.3% and 7%, the percentage of the third colloid is between 0% and 1.4%, the percentage of the sweetener is between 1% and 60%, and the percentage of the water is between 31.6% and 98.7%.

28. The stereolithography elastic film with adjustable peeling force in claim 27, wherein the percentage of the agar is between 0.5% and 5%, the percentage of the third colloid is between 0% and 1%, the percentage of the sweetener is between 5% and 55%, and the percentage of the water is between 39% and 94.5%.

29. A stereolithography elastic film with adjustable peeling force applied to a stereolithography 3D printing apparatus, and the stereolithography elastic film comprising:
a second colloid including a polyelectrolyte, a coagulant and water, and
a sweetener including at least one of a sugar and a sugar alcohol,
wherein a peeling force of the stereolithography elastic film is adjusted by adjusting a percentage of at least one of the polyelectrolyte, the coagulant, the sweetener and the water.

30. The stereolithography elastic film with adjustable peeling force in claim 29, further comprising a third colloid, the third colloid including one of locust bean gum (LBG), guar gum and konnyaku, the polyelectrolyte including a Kappa-carrageenan, and the coagulant including a potash salt, wherein the percentage of the Kappa-carrageenan is between 0.5% and 10%, the percentage of the third colloid is between 0% and 1.4%, the percentage of the potash salt is between 0% and 5%, the percentage of the sweetener is between 1% and 55%, and the percentage of the water is between 28.6% and 98.5%.

31. The stereolithography elastic film with adjustable peeling force in claim 30, wherein the percentage of the Kappa-carrageenan is between 0.7% and 7%, the percentage of the third colloid is between 0% and 1%, the percentage of the potash salt is between 0.1% and 3.5%, the percentage of the sweetener is between 5% and 50%, and the percentage of the water is between 38.5% and 94.2%.

32. The stereolithography elastic film with adjustable peeling force in claim 31, further comprising an Iota-carrageenan, and the coagulant including a calcium salt, wherein the percentage of the Iota-carrageenan is between 2% and 10%, the percentage of the Kappa-carrageenan is between 0.03% and 2%, the percentage of the third colloid is between 0% and 1.4%, the percentage of the calcium salt is between 0% and 2%, the percentage of the potash salt is between 0% and 5%, the percentage of the sweetener is between 1% and 40%, and the percentage of the water between 39.6% and 96.97%.

33. The stereolithography elastic film with adjustable peeling force in claim 32, wherein the percentage of the Iota-carrageenan is between 3% and 7%, the percentage of the Kappa-carrageenan is between 0.06% and 1.2%, the percentage of the third colloid is between 0% and 1%, the percentage of the calcium salt is between 0.1% and 1.5%, the percentage of the potash salt is between 0% and 3.5%, the percentage of the sweetener is between 5% and 30%, and the percentage of the water is between 55.8% and 91.84%.
